(19) United States
(12) Patent Application Publication
(10) Pub. No.: US 2018/0132665 A1
(43) Pub. Date: May 17, 2018

(54) Mixing Bowl with a Multi-Purpose Stand

(71) Applicant: Shannon Brown, Pahrump, NV (US)

(72) Inventor: Shannon Brown, Pahrump, NV (US)

(21) Appl. No.: 15/815,684

(22) Filed: Nov. 16, 2017

Related U.S. Application Data
(60) Provisional application No. 62/423,194, filed on Nov. 16, 2016.
(60) Provisional application No. 62/444,481, filed on Jan. 10, 2017.

(51) Int. Cl. A47J 43/07; A47G 19/10

(52) U.S. Cl. CPC A47J 43/0727; A47G 19/10

(57) ABSTRACT

A mixing bowl has a base with sidewalls extending upwardly and convexly therefrom and terminating in an upper peripheral rim, the rim defining an open mouth with the inner surface of the sidewalls defining the interior of the mixing bowl and the outer surface of the sidewalls defining the exterior of the mixing bowl, the interior of the mixing bowl being concave; and a plate and two support legs coupling the plate to the base, the support legs defining an aperture between the plate and the base, the aperture being sized so as to receive at least three fingers of a user.

### CROSS-REFERENCE TO RELATED APPLICATIONS

This application claims the benefit of U.S. Provisional Application Ser. No. 62/423,194 filed on Nov. 16, 2016, and U.S. Provisional Application Ser. No. 62/444,481 filed on Jan. 10, 2017, both of which are incorporated herein by reference.

### TECHNICAL FIELD

The present disclosure relates to kitchenware. More particularly, the present disclosure relates to mixing bowls.

### BACKGROUND

Mixing bowls are very convenient and are often used on a daily basis, whether it be for cooking, paint mixing, or some other use. Typically, the mixing bowl will have a rounded bottom surface, which may be slightly-flattened for remaining upright. In an effort to keep the bowl from moving or sliding unnecessarily, some manufactures have used rubbers or plastics as a coating on the bottom surface of the bowl. However, there is still a tendency for the bowl to move undesirably. Further, a mixing bowl having a flat bottom (e.g., square) wouldn't be ideal, as it would prevent proper mixing of the contents, especially when using mixers or beater systems that depend on the inner portion of the mixing bowl to be round/hemispherical. One of the drawbacks of traditional mixing bowls is that they lack a handle. Accordingly, the bowl can be difficult to hold when mixing and/or pouring out the contents. Efforts have been made in the art to solve several issues. One such effort was to add handles to mixing bowls or other containers. The handles are typically mounted around the upper circumference of the bowl or are mounted vertically on the exterior of the bowl. However, this still requires that a user grip the handle(s) to pour the contents from the bowl. While this may be easy for many users, there are categories of users that cannot grip handles. For example, individuals with arthritis may not be able to grip a handle sufficiently to lift it—or if they can, it may be painful or otherwise uncomfortable. Likewise, individuals that lack opposing digits, either as a result of an abnormality at birth or the result of an accident, cannot grip a handle. Accordingly, there is a need for a mixing bowl that can be stabilized, lifted, tilted, and inverted, without the need for grip strength. The present disclosure seeks to solve these and other problems.

### SUMMARY OF EXAMPLE EMBODIMENTS

A mixing bowl comprises a base with sidewalls extending upwardly and convexly therefrom and terminating in an upper peripheral rim, the rim defining an open mouth with the inner surface of the sidewalls defining the interior of the mixing bowl and the outer surface of the sidewalls defining the exterior of the mixing bowl, the interior of the mixing bowl being generally concave; and a plate and two support legs coupling the plate to the base, the support legs defining an aperture between the plate and the base, the aperture being sized so as to receive at least three fingers of a user.

### BRIEF DESCRIPTION OF THE DRAWINGS

FIG. 1 is a perspective view of a mixing bowl;

FIG. 2 is a front elevation view of a mixing bowl;

FIG. 3 is a side elevation view of a mixing bowl;

FIG. 4 is a top plan view of a mixing bowl;

FIG. 5 is a bottom plan view of a mixing bowl;

FIG. 6 is a perspective view of a mixing bowl in one method of use;

FIG. 7 is a perspective view of a mixing bowl with spouts;

FIG. 8A is a perspective view of a mixing bowl with removable stand;

FIG. 8B is a perspective view of a mixing bowl with removable stand;

FIG. 9 is a perspective view of a mixing bowl; and

FIG. 10 is a side elevation view of a mixing bowl with a vertical handle.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

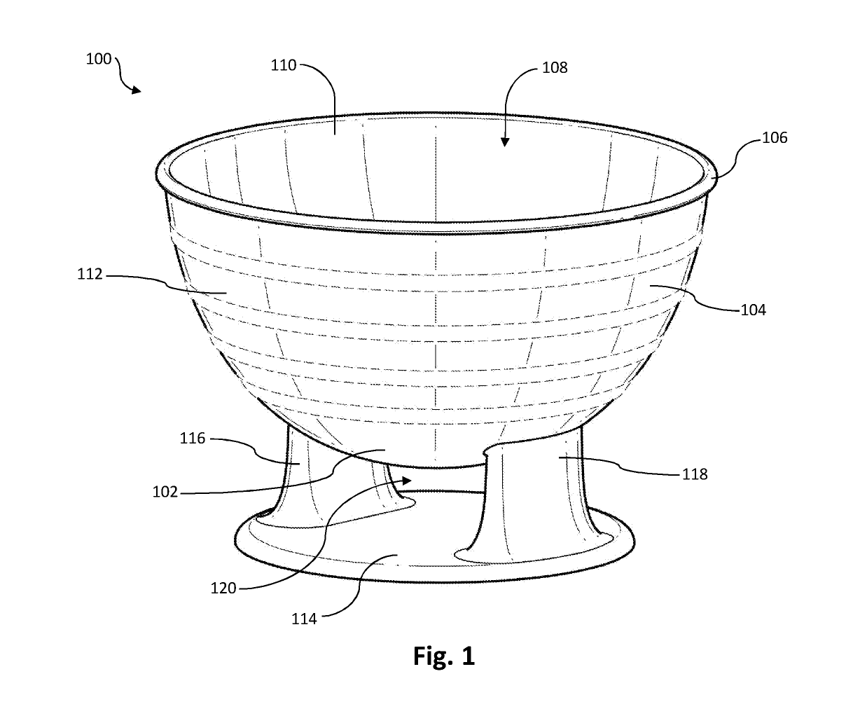

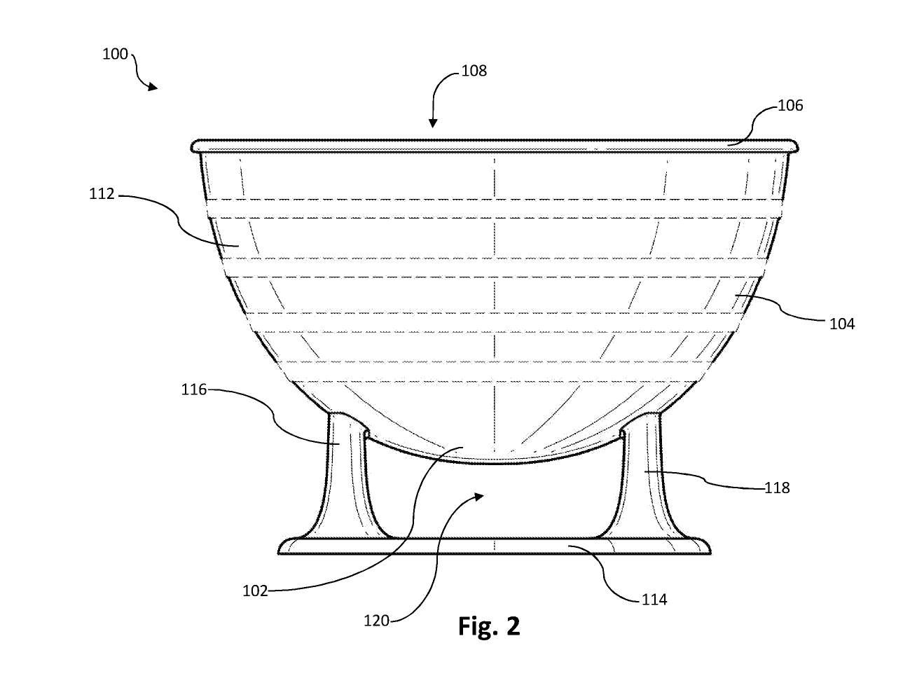

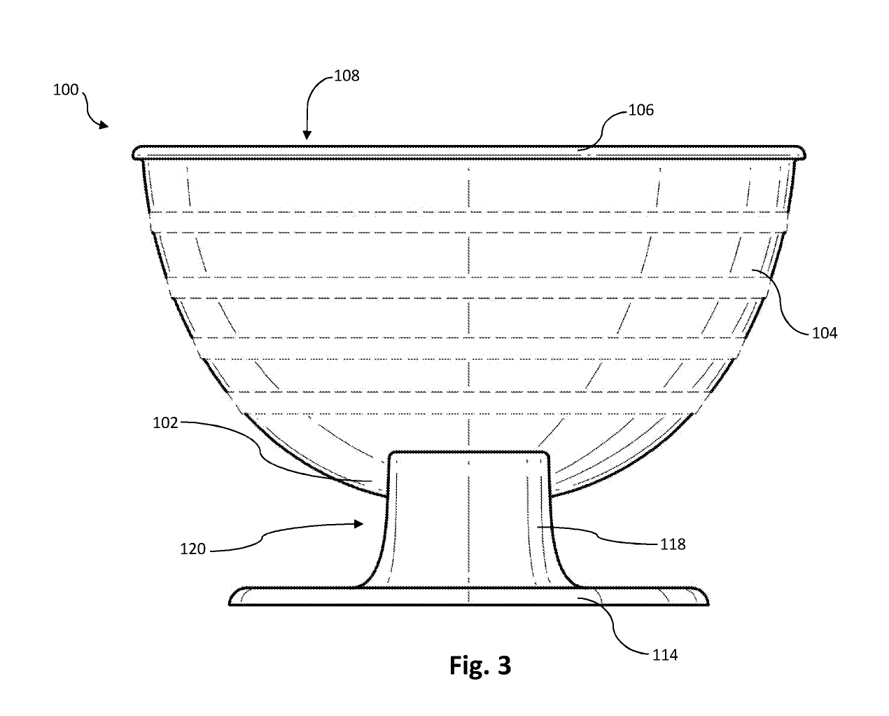

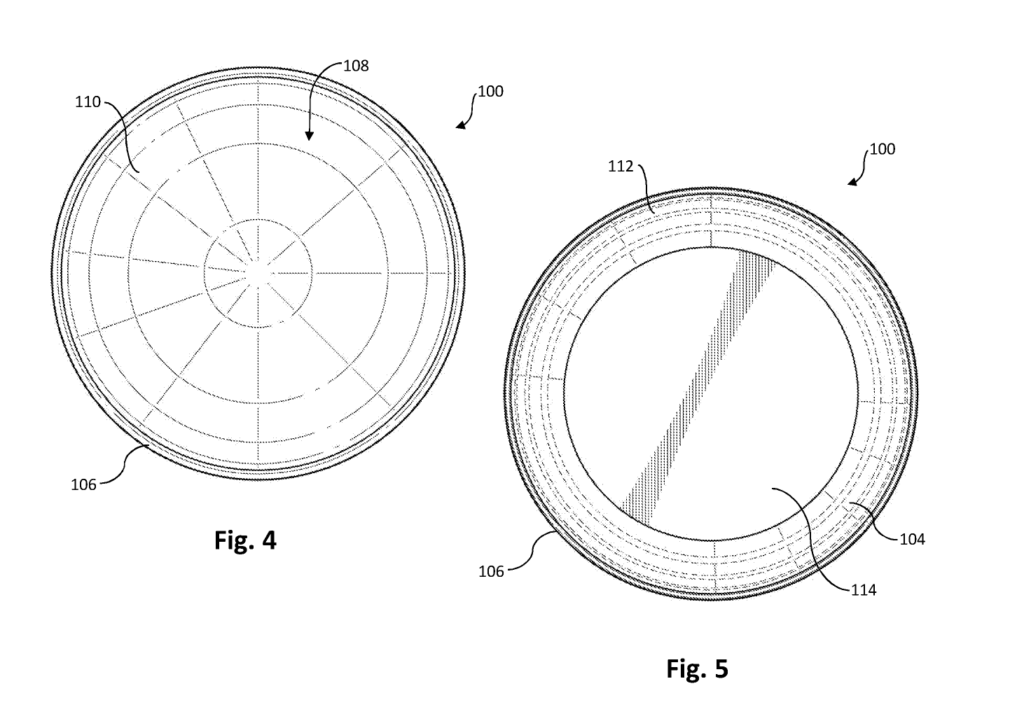

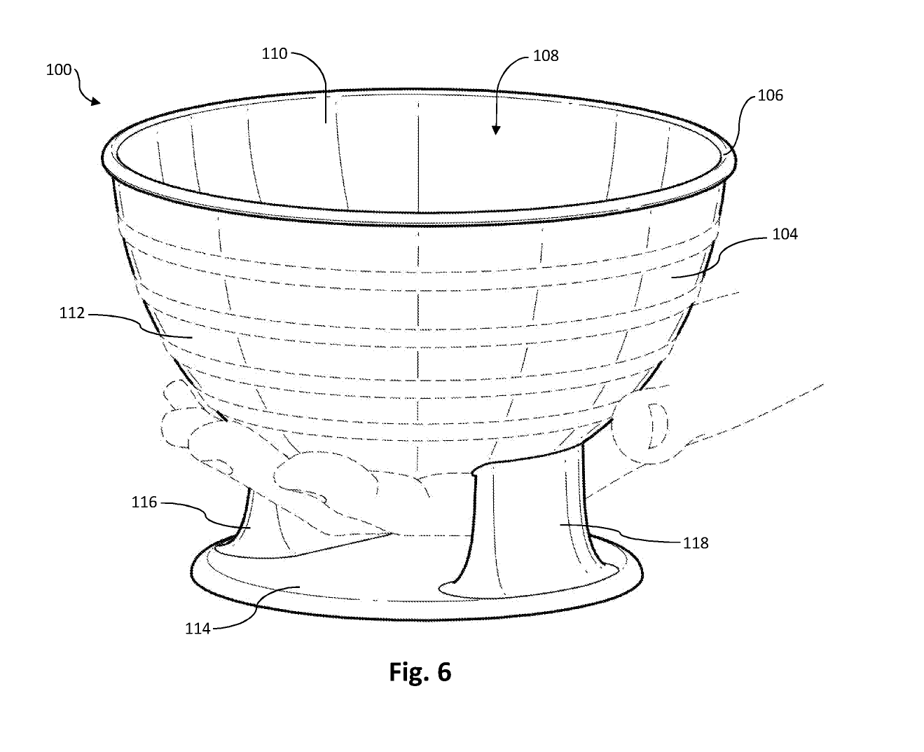

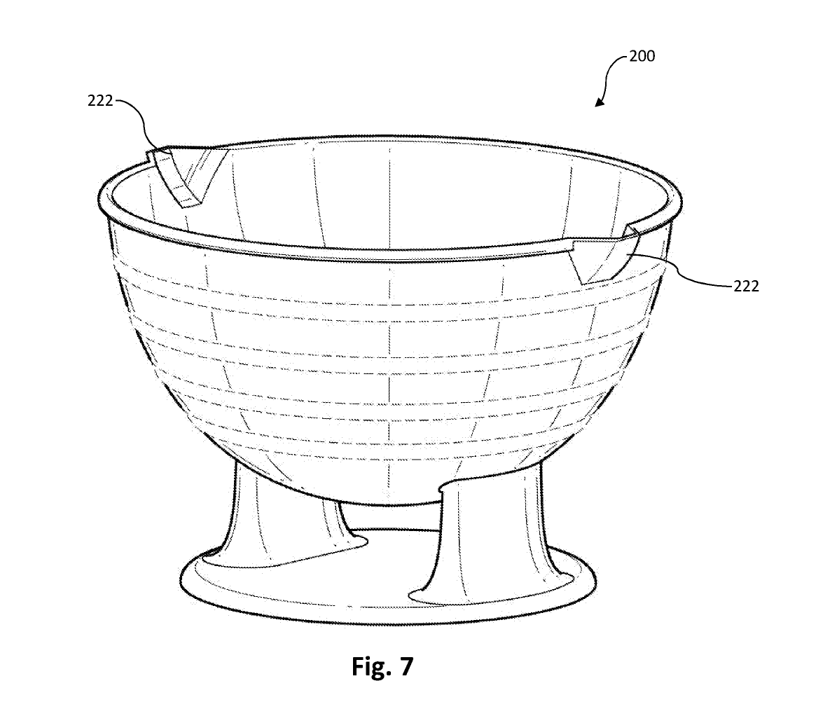

It will be appreciated that the mixing bowl disclosed herein solves the need for a mixing bowl that can be stabilized, lifted, and poured that doesn't require gripping. Accordingly, in one embodiment, as shown in FIGS. 1-6, a mixing bowl 100 comprises a base 102 with sidewalls 104 extending upwardly and convexly therefrom and terminating in an upper peripheral rim 106, the rim 106 defining an open mouth 108 with the inner surface 110 of the sidewalls 104 defining the interior of the mixing bowl and the outer surface 112 of the sidewalls 104 defining the exterior of the mixing bowl, the interior of the mixing bowl being concave. The mixing bowl 100 further comprises a plate 114 and two support legs 116, 118 coupling the plate 114 to the base 102, the support legs 116, 118 defining an aperture 120 between the plate 114 and the base 102, the aperture 120 being sized so as to receive a user's hand, or at least three fingers of a user's hand, (as best shown in FIG. 6). In one embodiment, the plate may have a non-slip surface on the bottom thereof (e.g., rubberized surface, rubber feet, or similar non-slip equivalent).

Therefore, in one non-limiting example of use, a user would place the mixing bowl 100 on a counter, where the plate 114 keeps the bowl upright and stabilized. The user may then place contents in the mixing bowl 100 via the open mouth 108. The user may then mix the contents in the mixing bowl 100. In the event the user desires to use aggressive agitation, the user may place their fingers through the aperture 120 so that their hand conforms to the bottom of the bowl. The support legs 116, 118 preferably abut the user's hand creating stability for the mixing bowl 100 without the need for a user to grip anything. When a user is ready to lift and/or pour contents from the mixing bowl 100, the user may easily lift and support the mixing bowl 100 without gripping. Because at least one support leg 116, 118 abuts the user's hand, the user may easily pour the contents with the mixing bowl 100 being supported on the user's hand via the plate 114 and support leg 116, 118. Accordingly, a user may completely invert the mixing bowl 100 without needing to grip, as the mixing bowl 100 is then supported on the back side of the user's hand via plate 114. Therefore, a user is able to mix, lift, and pour the contents of the mixing bowl 100 without needing to grip any portion of the mixing bowl 100, overcoming the issues in the prior art.

While the plate 114 is shown in a circular configuration throughout the figures, that shape should not be considered limiting in scope. In other words, the plate 114 may be circular, oval, polygonal, or any other shape that would support the bowl/kitchenware to which it is connected.

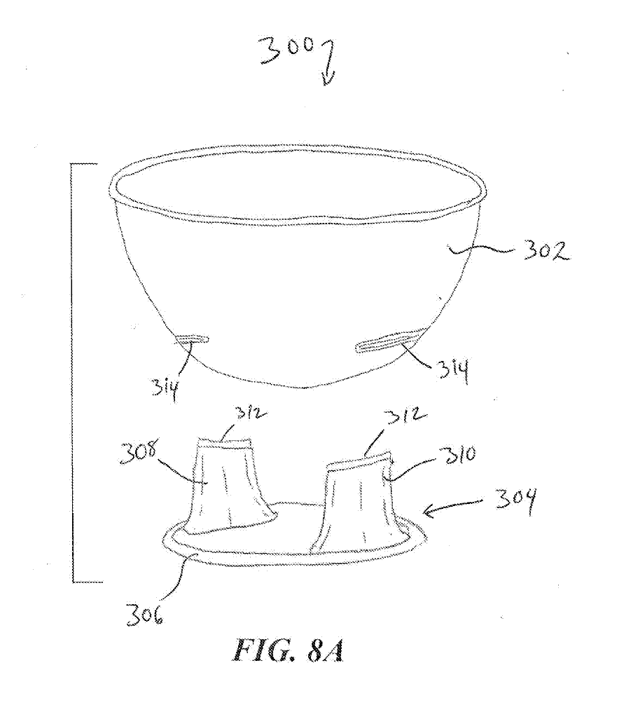

As shown in FIG. 7, the mixing bowl 200 may have varying configurations, such as spouts 222. Further, it will be appreciated that while the mixing bowls 100, 200 have been illustrated as generally hemispherical, such form factor is not required. In other words, any variety of kitchenware may have the plate and support legs attached thereto, extending the ability of users to carry items without the need to grip. For example, a casserole dish may have a plate and support legs coupled thereto for the same benefits outlined above.

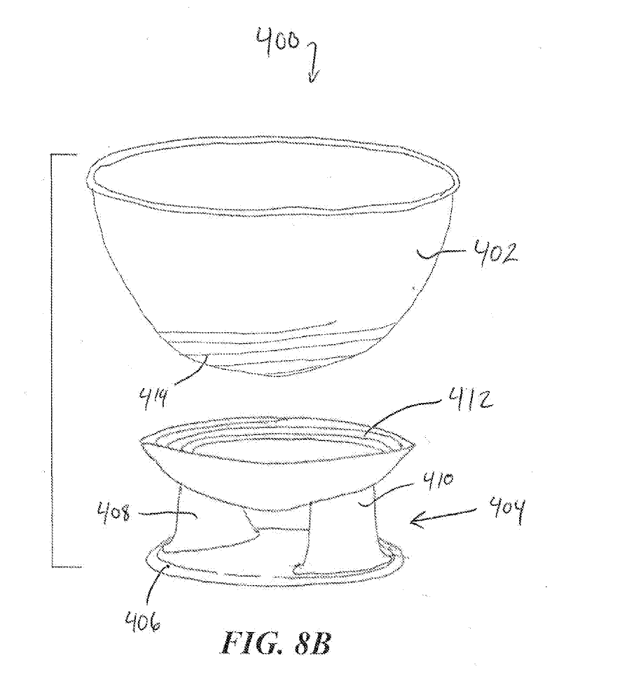

As shown generally in FIG. 8A, a mixing bowl apparatus 300 comprises a bowl 302 having a removable stand 304, the stand 304 comprising a plate 306 with one or more support legs 308, 310 attached thereto and extending vertically therefrom, the distal ends of the support legs 308, 310 being removably attachable to the bowl 302 using an attaching means. As shown in FIG. 8A, the attaching means may be tongue 312 and groove 314 for a twist lock configuration. The twist and lock system may be on the sides as shown, or on the underside of the bowl 302. As shown in FIG. 8B, a mixing bowl apparatus 400 comprises a bowl 402 and a removable stand 404. The removable stand 404 comprising a plate 406 with one or more support legs 408, 410 attached thereto and extending vertically therefrom, the distal ends of the support legs 408, 410 being coupled to a threaded coupler 412. Threaded coupler 412 engages the threads 414 on the lower portion of bowl 402.

Another method of having a removably attachable stand would comprise posts with spring-loaded locking pins. In other words, a short post with a spring-loaded locking pin may descend from near the base of the bowl. The support legs may have a receiving aperture for receiving the post with a side aperture for receiving the locking pin. Accordingly, a user desiring to remove the plate and support legs may depress the locking pin and lift the bowl (or other kitchenware) from the support leg(s).

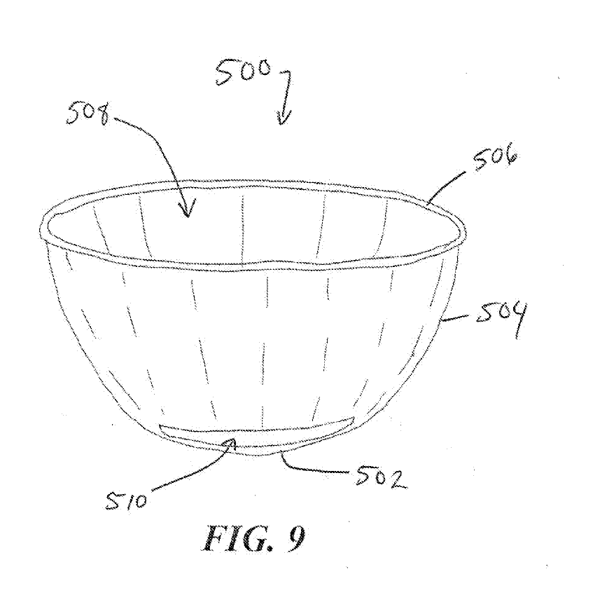

In one embodiment, as shown in FIG. 9, a mixing bowl 500 comprises a base 502 with peripheral walls 504 extending arcuately upwardly therefrom and having an upper wall rim 506 forming a mouth 508 of a bowl, the interior of the bowl being generally hemispherical to facilitate blending or mixing, and wherein the base portion 502 comprises at least one aperture 510 configured to receive one or more fingers of a user.

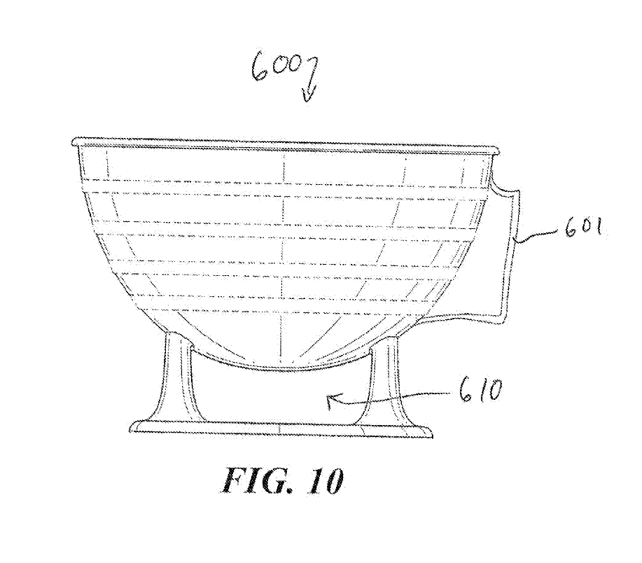

In one embodiment, as shown in FIG. 10, a mixing bowl 600 may further comprise a vertical handle 601. Having a vertical handle 601 may be useful to aid the user in holding the mixing bowl 600 when vigorously mixing the contents thereof, if needed. The user may then opt to use the lower aperture 610 when tilting or otherwise inverting the mixing bowl 600 to extract its contents.

While the illustrations show a mixing bowl, other kitchenware may be used, such as a casserole dish, where it may be desirable to remove the stand portion for use in ovens or microwaves.

Therefore, it is appreciated that the mixing bowl disclosed herein allows a user, without grip strength, to be able to tilt, pour, invert, or otherwise easily extract the contents of the mixing bowl.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention as defined in the appended claims. Additionally, it is not intended that the scope of patent protection afforded the present invention be defined by reading into any claim a limitation found herein that does not explicitly appear in the claim itself.

What is claimed is:

1. A mixing bowl, comprising:
a base with sidewalls extending upwardly and convexly therefrom and terminating in an upper peripheral rim, the rim defining an open mouth with the inner surface of the sidewalls defining the interior of the mixing bowl and the outer surface of the sidewalls defining the exterior of the mixing bowl, the interior of the mixing bowl being concave; and
a plate and two support legs coupling the plate to the base, the support legs defining an aperture between the plate and the base, the aperture being sized so as to receive at least three fingers of a user.

2. The mixing bowl of claim 1, wherein the support legs are removably attachable to the base.

3. The mixing bowl of claim 1, wherein the rim further defines at least one pouring spout.

4. The mixing bowl of claim 1, further comprising a non-slip surface on the underside of the plate.

5. A mixing bowl, comprising:
a base with sidewalls extending upwardly and convexly therefrom and terminating in an upper peripheral rim, the rim defining an open mouth with the inner surface of the sidewalls defining the interior of the mixing bowl and the outer surface of the sidewalls defining the exterior of the mixing bowl, the interior of the mixing bowl being concave; and
a plate and a support leg coupling the plate to the base, the support leg comprising an aperture sized so as to receive at least three fingers of a user.

6. The mixing bowl of claim 5, wherein the support leg is removably attachable to the base.

7. The mixing bowl of claim 5, wherein the rim further defines at least one pouring spout.

8. A mixing bowl, comprising:
a plate;
at least one support leg extending upwardly from the plate;
a bowl coupled to, and supported by, the at least one support leg; and
an aperture interposed between the bowl and the plate and configured to receive fingers of a user.
